(19) United States
(12) Patent Application Publication
(10) Pub. No.: US 2020/0327216 A1
(43) Pub. Date: Oct. 15, 2020

(54) PORTABLE AUTHENTICATION APPARATUS AND SELF-ENROLLMENT METHOD FOR ENROLLING AUTHENTICATION DATA IN THE APPARATUS

(71) Applicant: AUTHENTREND TECHNOLOGY INC., Taipei City (TW)

(72) Inventors: JHIH-YOU LIN, Taipei City (TW); CHI-FENG HUANG, Taipei City (TW)

(21) Appl. No.: 16/513,788

(22) Filed: Jul. 17, 2019

(30) Foreign Application Priority Data
Apr. 10, 2019 (TW) 108112532

(51) Int. Cl. G06F 21/34; G06F 21/32

(52) U.S. Cl. CPC G06F 21/34; G06F 21/32

(57) ABSTRACT

A portable authentication apparatus and a self-enrollment method for enrolling authentication data in the apparatus are provided. The method is performed by a micro-controller of the portable authentication apparatus. The micro-controller is communicated with a biometric identification module of the apparatus so as to implement the functionality of self-enrollment in the apparatus. In the method, the micro-controller receives a request for enrolling authentication data, and the apparatus enters an enrollment mode. At this moment, the apparatus initiates an enrollment procedure and issues an indication signal. The apparatus starts reading authentication data, and continuously reads the authentication data until the enrollment procedure is completed. The authentication data is stored into a memory of the portable authentication apparatus when the enrollment procedure has been completed.

### CROSS-REFERENCE TO RELATED PATENT APPLICATION

This application claims the benefit of priority to Taiwan Patent Application No. 108112532, filed on Apr. 10, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The disclosure is generally related to a technology for performing enrollment procedure in an authentication apparatus, and more particularly to a self-enrollment method that allows a portable authentication apparatus to complete a biometric enrollment procedure by the apparatus itself for enrolling the authentication data.

### BACKGROUND OF THE DISCLOSURE

Generally, an identity authentication technology using information related to accounts and passwords is adopted in an information system. However, a drawback of the conventional security mechanism is that the account and password rely on a user committing such information to memory, and that the security level of such information may not be high enough to protect user identity. Some biometric technologies such as fingerprint recognition, facial recognition such as 3D facial scanning, iris and finger vein recognition are available to conduct the identity authentication. However, since these authentication mechanisms require corresponding hardware and system setups, such biometric technologies are still not universally adopted.

Further, some modern identity authentication technologies are already bound with mobile devices, wearable devices or devices for user identification. However, such identity authentication technologies also require corresponding hardware or systems, making it difficult to promote widespread application thereof.

Regardless of what specific purpose the above mentioned conventional security technologies are used for, such technologies are still not seeing widespread use in identify authentication for personalized devices such as mobile devices.

### SUMMARY OF THE DISCLOSURE

In response to the above-referenced technical inadequacies, the present disclosure provides a portable authentication apparatus and a self-enrollment method for enrolling authentication data in the apparatus.

The disclosure is related to a portable authentication apparatus as an authentication device for users to log into various computer devices. A way of logging into the system by the portable authentication apparatus substitutes for a traditional way of logging into the system using account name and password. The portable authentication apparatus integrates one or more authentication technologies for processing various authentication procedures. Therefore, the apparatus can be applied for various authentication purposes.

The authentication technologies supported by the portable authentication apparatus need to obtain authentication data such as a fingerprint. In particular, the portable authentication apparatus does not rely on any external device for enrolling the authentication data. The apparatus perform a self-enrollment method for enrolling the authentication data in the apparatus.

The main components of the portable authentication apparatus include a micro-controller unit that is used to operate the circuit module of the apparatus. The circuit modules are such as multiple communication modules that can be used to communicate with a host for identity verification. A biometric module is included in the apparatus. A security authentication module and a power management module are also included in the apparatus. The security authentication module generates a security code for authentication from biometric features generated by the biometric module.

According to one of the embodiment of the self-enrollment method, in the portable authentication apparatus, the micro-controller unit receives a request for enrolling authentication data. Then, the portable authentication apparatus enters an authentication data enrollment mode. The apparatus can prompt the user to acknowledge the apparatus initiates an enrollment procedure and starts to read authentication data. After that, the portable authentication apparatus continues receiving authentication data via an authentication interface until the enrollment procedure is done. The enrolled authentication data can then be stored into a memory of the portable authentication apparatus.

Further, when receiving the request for enrolling authentication data, the software process running in the portable authentication apparatus firstly enquires if the memory includes at least one enrolled authentication data. If at least one authentication data exists, the authentication data is used to process an authentication procedure and the apparatus starts an enrollment procedure.

In one embodiment, an indicator light is used to prompt the user that the portable authentication apparatus enters the authentication data enrollment mode. The apparatus then starts to read authentication data or starts the authentication procedure.

Further, the apparatus continuously determines if the enrollment procedure is done. When the enrollment procedure fails, the authentication data buffered in the apparatus will be erased and the enrollment procedure is terminated. Otherwise, the apparatus continues to receive the authentication data and also determines if the procedure fails.

Preferably, the authentication data can be biometric data. The authentication interface can be a biometric feature access interface that is used to read the biometric features and form the biometric data.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram depicting a fundamental framework of a portable authentication apparatus in one embodiment of the disclosure;

FIG. 2 is a circuit block diagram of the portable authentication apparatus in one embodiment of the disclosure;

FIG. 3 is a schematic diagram showing the portable authentication apparatus under a certain scenario;

FIG. 4 is another schematic diagram showing the portable authentication apparatus under another scenario;

FIG. 5 is one further schematic diagram showing the portable authentication apparatus under yet another scenario;

FIG. 6 shows a first flow chart describing a self-enrollment method performed by the portable authentication apparatus in one embodiment of the disclosure;

FIG. 7 shows a second flow chart describing the self-enrollment method performed by the portable authentication apparatus in one further embodiment of the disclosure; and

FIG. 8 shows a flow chart describing the self-enrollment method according to one embodiment of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The disclosure is related to a portable authentication apparatus. The portable authentication apparatus supports self-enrollment for enrolling authentication data, e.g. biometric authentication data, in the apparatus without any assistance from an external device or software. After the self-enrollment method is completed in the apparatus, the new authentication data can be used in the next authentication process when starting the apparatus. Further, the new authentication data will successfully activate the apparatus for the purpose of logging into the host or any service that links with the portable authentication apparatus.

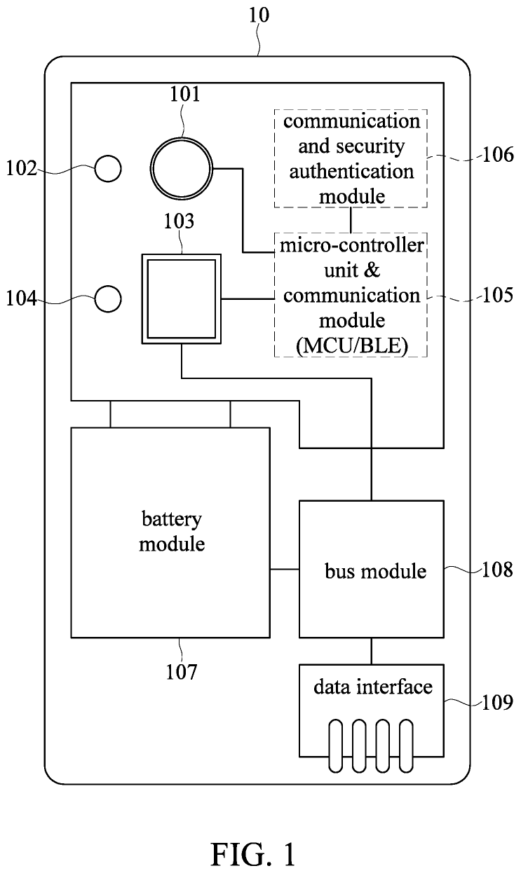

A concept of design of the authentication apparatus of the disclosure is preferably an easy-to-carry device. In general, miniaturization is one of the goals for designing the portable authentication apparatus. For example, the portable authentication apparatus can be, but not limited to, a card type as shown in FIG. 1, a bracelet type device or a USB-type dongle. The portable authentication apparatus integrates multiple authentication technologies. An operating method of the disclosure allows the portable authentication apparatus to perform various authentication processes for various identity authentication purposes.

The portable authentication apparatus is configured with a connection protocol that is used to decide which communication module is used to connect with a host to be authenticated. The portable authentication apparatus can operate various communication protocols and authentication processes based on the connection protocol. In an exemplary example, when the portable authentication apparatus connects with a host via a data interface, a first wireless communication module of the apparatus is de-activated. After the portable authentication apparatus is removed from the host, the first wireless communication module is activated to conduct the authentication process. When the first wireless communication module is de-activated, a second wireless communication module of the apparatus is activated to conduct the authentication process.

It is worth mentioning that, before the portable authentication apparatus starts to function, the portable authentication apparatus should first be initialized. For example, when the portable authentication apparatus is plugged into a computer device via USB, the portable authentication apparatus requires a user to enroll his authentication data such as biometric feature, e.g. fingerprint. The portable authentication apparatus is also enrolled in the computer system where a corresponding software program is installed. A way of logging into the system by the portable authentication apparatus is used to substitute for an authentication method originally performed in the computer system. In the meantime, the software program assists the user to enroll the user's biometric feature into the portable authentication apparatus. Alternatively, a micro-controller unit inside the apparatus can conduct the self-enrollment method for directly enrolling the biometric authentication data into the apparatus. The portable authentication apparatus also stores an encryption key (i.e. private key), and the encryption key is provided for a security algorithm to calculate a security code from the biometric feature by a security authentication module of the portable authentication apparatus. The security code becomes an identity of the portable authentication apparatus.

Thus, the computer system can obtain the security code from the portable authentication apparatus, and the security code acts as a certification for logging into the computer system. The security code can also allow the computer system to access a network service via a web browser under a Fast ID Online (FIDO) mechanism. The related embodiments are as follows.

Reference is made to FIG. 1, which shows a fundamental framework of a portable authentication apparatus 10 according to one embodiment of the disclosure. While the present embodiment shows a card-type portable authentication apparatus 10, the appearance of the apparatus is not limited by the present disclosure.

A housing of the portable authentication apparatus 10 includes a power switch 101 that is electrically connected with an internal power management circuit. The power switch 101 allows a user to turn on or turn off the portable authentication apparatus 10 by touch. The housing has a power indicator light 102 that can be used to show a power state of the apparatus 10 with various light signals such as flashing, breathing and/or colors. The power state indicates statuses such as power-charging, voltage levels, switched on/off or low-voltage warnings of the apparatus 10. Other indicators can also be added for indicating various states of the apparatus 10. One of the indicators is an operation indicating light 104 that utilizes light signals to show an operating state of the apparatus 10. For example, since the portable authentication apparatus 10 integrates various communication and authentication technologies, the operation indicating light 104 with flashing, breathing or color-changing lights can be used to indicate an operation of each of the communication modules of the apparatus 10, a process of authentication operated in the apparatus 10 or whether the apparatus operates correctly or not.

The portable authentication apparatus 10 includes a biometric feature access interface 103 that is connected with a biometric recognition circuit inside the portable authentication apparatus 10. The biometric recognition circuit is exemplarily a fingerprint scanner or the like. One of the purposes of the biometric recognition circuit is to obtain a user's biometric feature, e.g. fingerprint, that is used to generate data such as a security code for the authentication process. The biometric feature allows the portable authentication apparatus 10 to be applied for various authentication purposes.

The fingerprint, as an example, is obtained when the user's finger touches the biometric feature access interface 103. At this time, an indicator light lights up. For example, a green light lights up if the fingerprint is successfully read by the apparatus 10, and another light, e.g. a red light, lights up if the apparatus 10 fails to read the fingerprint.

The portable authentication apparatus 10 is optionally an integrated circuit (i.e. IC) manufactured by a high-end process technology. The apparatus 10 integrates multiple communication circuits and protocols. In an exemplary example, the circuits integrated into the apparatus 10 include a micro-controller unit (MCU), a micro-controller for the communication circuits such as Bluetooth™ and Bluetooth Low Energy (BLE), a micro-controller unit and communication module 105, and a security chip that integrates a specific communication circuit, e.g. an NFC, and a communication and security authentication module 106 of the security chip.

As an example when activating the Bluetooth communication module, a related indicator light lights up and flashes to indicate that some connection packets are being broadcasted and that the Bluetooth communication module is waiting to be paired with another device. After being successfully paired with the device, an indicator light of the apparatus 10 is stable and constant.

The portable authentication apparatus 10 is preferably a portable device. The portable device may be powered by a connected external host that embodies the bus module 108 of the apparatus 10 via USB. The portable authentication apparatus 10 also supports an authentication process with wireless communication and therefore has an independent power supply such as a battery module 107. The power management circuit (not shown) supplies power to the portable authentication apparatus 10 by the battery module 107. The apparatus 10 can also receive external power via the bus module 108 and the data interface 109. It is worth mentioning that, under the design concept of miniaturization for the portable authentication apparatus 10, the data interface 109 can be designed as a retractable structure. When the apparatus 10 links with a host via the bus module 108 and the data interface 109, the portable authentication apparatus 10 is initiated and enters a charging mode or a data transmission mode.

In an exemplary example, when the portable authentication apparatus 1 is under the charging mode when connecting with an external power supply via the data interface 109, an indicator light, e.g. a flashing light, is displayed. If a charging process is completed, a power management module instructs that the indicator light is turned off or in another lighting mode. If the portable authentication apparatus 10 is at a low voltage state, a specific light lights up for warning that the battery is about to be exhausted.

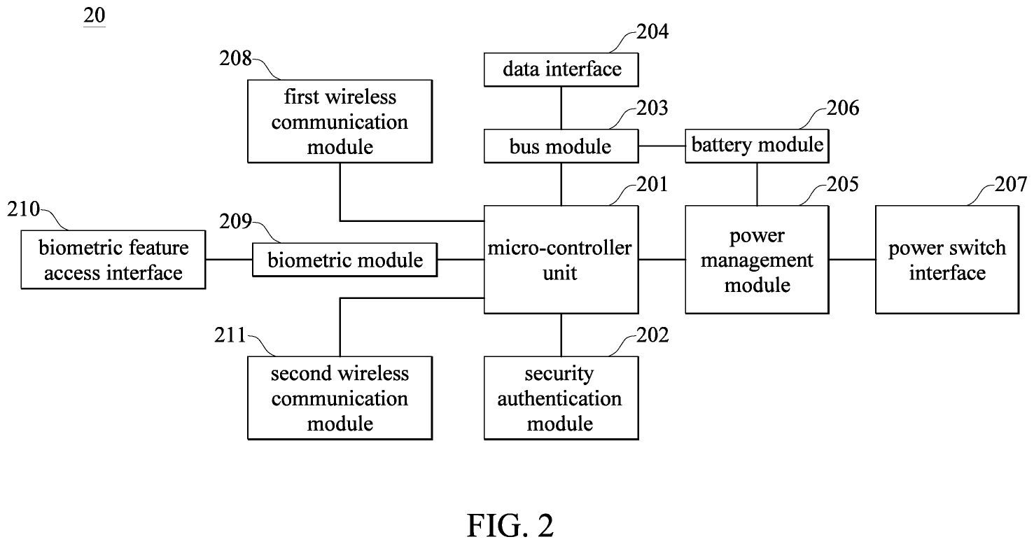

FIG. 2 shows a circuit block diagram of the portable authentication apparatus in one embodiment of the present disclosure. The figure depicts main circuits of the portable authentication apparatus 20. The circuits can be divided into different functional modules. In practice, part of the functional modules can be integrated into one circuit system or implemented by software that is cooperated with hardware.

The portable authentication apparatus 20 can be a card-type device that is an independently-operated device. The internal battery module 206 supplies power to the portable authentication apparatus 20 through the power management module 205. The power management module 205 is used to process the power supplies from the battery module 206 or an external power source in a wired or wireless charging method. The apparatus 10 provides a power switch interface 207 for the user to touch or click for turning on or turning off the apparatus 10. In order to differentiate functions of the power switch interface 207 for turning on or off the communication modules, the portable authentication apparatus 20 is turned off by pressing and holding the power switch interface 207 for a while.

A micro-controller unit 201 of the portable authentication apparatus 20 is used to control operations of the circuit modules of the portable authentication apparatus 20, and in particular to operate the self-enrollment method in the apparatus 20. The portable authentication apparatus 20 includes a security authentication module 202 that is configured to be a secure element (SE), and can be implemented by a security chip. A specific communication circuit can be integrated into one security chip.

The portable authentication apparatus 20 includes a biometric module 209 that is electrically connected with a micro-controller unit 201. A biometric feature access interface 210 of the portable authentication apparatus 20 is used to read a biometric feature. Various biometric recognition technologies can be used in the apparatus 10 for generating the authentication data. The security authentication module 202 is electrically connected with the micro-controller unit 201 to obtain the biometric feature generated by the biometric module 209 by the micro-controller unit 201. In one embodiment of the disclosure, a hash algorithm is applied to the biometric feature for calculating a hash value or a digest. An encryption key stored in the security authentication module 202 is then retrieved. The encryption key is incorporated to the encryption algorithm for calculating the hash value so as to create a digital signature. The signature can act as the security code for authentication.

In one further embodiment of the disclosure, the security authentication module 202 includes a security chip that has a processor. Therefore, the security chip is able to verify biometric data, e.g. the security code, quickly. The security chip has a memory that can be used to store the encryption key and the data relating to the biometric feature for comparison. When the portable authentication apparatus 20 is initiated to process authentication, the biometric feature can be obtained by the biometric module 209. The biometric feature is then compared with the data stored in the memory of the security chip. The security chip allows the portable authentication apparatus 20 to conduct an initial identity authentication. In one embodiment, after obtaining the biometric feature, a hash value is calculated. The encryption key of the security authentication module 202 is used to create a signature based on the information such as host data, e.g. time and hardware information, and a certificate provided by a certificate authority (i.e. CA). The digital signature calculated by the hash algorithm is able to ensure source accuracy and content integrity. Therefore, a security code is generated. The security code is then transmitted to the host to which the apparatus 10 is connected. After decryption in the host, the authentication can be performed once the hash algorithm confirms the source accuracy and integrity of the biometric feature.

Further, multiple communication modules are included in the portable authentication apparatus 20. Each of the communication modules is electrically connected with the micro-controller unit 201. The portable authentication apparatus 20 integrates functions of the communication protocols and authentication processes. One of the communication modules such as a bus module 203, e.g. USB, and a data interface 204, e.g. USB interface, is for linking an external device. The portable authentication apparatus 20 uses the data interface 204 to plug in the host. The host is an electronic device such as a computer host, an electronic device, or an access control device, requiring identity authentication.

The communication modules of the portable authentication apparatus 20 may include more than one wireless communication module, e.g. a first wireless communication module 208 and a second wireless communication module 211. According to one of the embodiments, the first wireless communication module 208 is a Bluetooth communication module with Bluetooth™ technology, and the second wireless communication module 211 is a Near-Field communication module (i.e. NFC). The Bluetooth communication module can be a dual-mode communication chip that can be operated under a Bluetooth communication protocol or a Bluetooth Low Energy (BLE) protocol.

The biometric module 209 can be a fingerprint recognition module that cooperates with the biometric feature access interface 210 disposed on a surface of the portable authentication apparatus 20 for scanning a fingerprint image. The biometric feature can be extracted from the fingerprint image by the fingerprint recognition module. The security authentication module 202 accordingly generates the security code as shown in the above embodiments. The security code acts as a reference for identity authentication.

According to one of the embodiments of the portable authentication apparatus, when the portable authentication apparatus connects with a host, the apparatus is used to log in a computer system instead of the original authentication process. The portable authentication apparatus can be used for security authentication when executing a software program or accessing data.

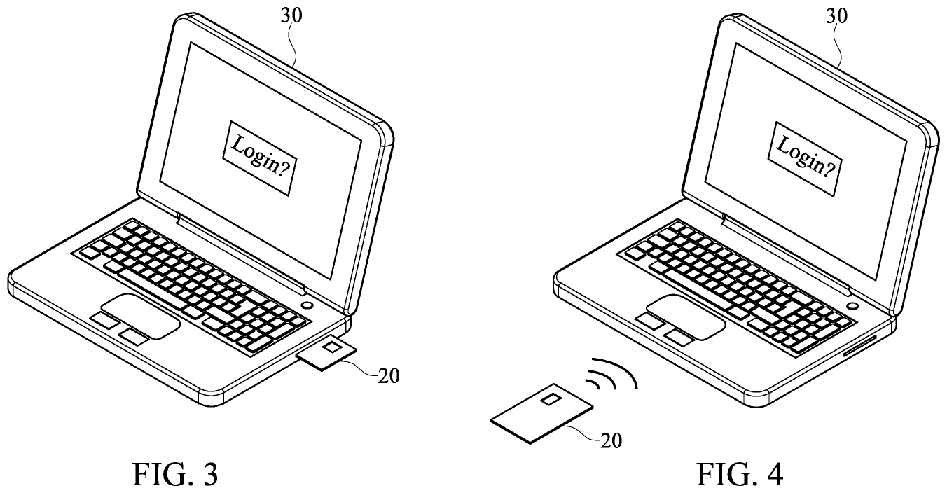

Referring to FIG. 3, a scenario using the portable authentication apparatus according to the present disclosure is shown.

The portable authentication apparatus 20 becomes an authentication apparatus used for logging into a computer device 30 when it plugs in the computer device 30 via the data interface, e.g. USB interface. When a user initiates a biometric authentication process, the portable authentication apparatus scans the user's biometric feature, e.g. fingerprint. The biometric feature is used to generate the security code. The security code is transmitted to the computer device 30 via the data interface. The user can successfully log in the computer system after passing the identity authentication with the biometric feature.

FIG. 4 shows another schematic diagram of a scenario where the portable authentication apparatus 20 uses a wireless communication technology to perform the biometric authentication. A wireless communication protocol is used to transmit the hashed security code to the computer device 30. In the computer device 30, the security code is encrypted for authentication. The user can log in the computer system, access data, executes software, and/or obtain a network service after passing the identity authentication process.

Moreover, the portable authentication apparatus can be used to connect and open an access control device. When the apparatus connects with a system of the access control device, the access control device can be successfully opened if a security authentication process has been performed.

Further, the portable authentication apparatus can be used as an authentication apparatus for processing a payment procedure.

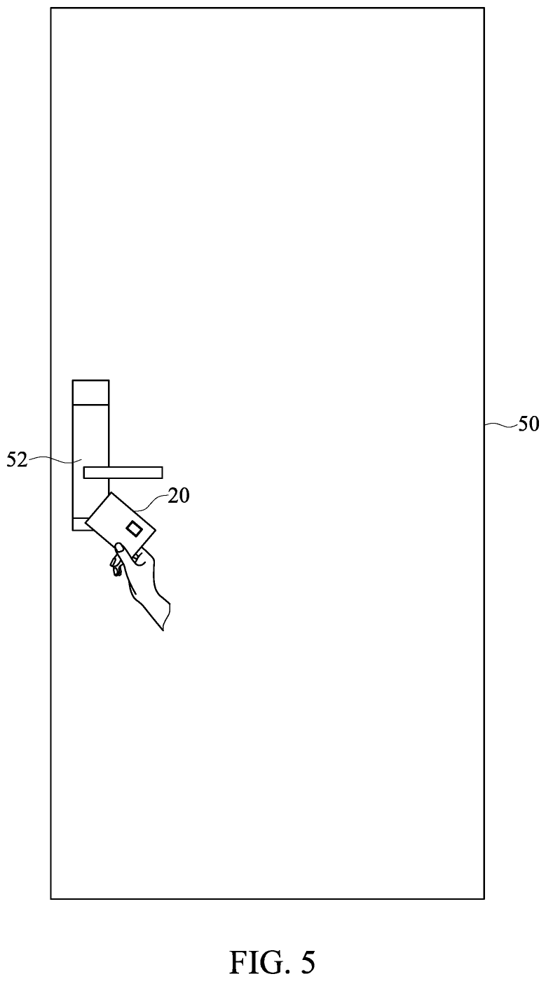

Reference is made to FIG. 5 showing another schematic diagram in a scenario where a portable authentication apparatus 20 is used to open an access control device. The access control device is such as a gate 50 disposed with a gate lock 52. The gate lock 52 includes a host that is configured to be paired with the portable authentication apparatus 20. When a user uses the portable authentication apparatus 20 to conduct biometric authentication, the portable authentication apparatus 20 transmits a security code to the host of the gate lock 52 under a wireless communication protocol. The wireless communication there-between is performed in compliance with a Near-Field Communication (i.e. NFC) protocol. A software process running in the host of the gate lock 52 conducts the identity authentication. The gate 50 associated with the gate lock 52 is opened after the identity authentication. The portable authentication apparatus 20 can also be applied to other access control devices, e.g. a gate of a parking lot, an elevator, or any gate requiring access control.

According to one of the embodiments of the portable authentication apparatus, in addition to processing an enrollment procedure by connecting to an external computer device, the portable authentication apparatus can self-enroll a new authentication data into the apparatus. The authentication data is such as biometric data that is used to substitute for the original identity authentication method in a computer system. In one embodiment of the disclosure, the new authentication data can be processed by a hash algorithm so as to generate a hash value. A key stored in a security chip, e.g. the security authentication module 202, is used to encrypt the hash value, and the encrypted value is then stored in a memory of the apparatus.

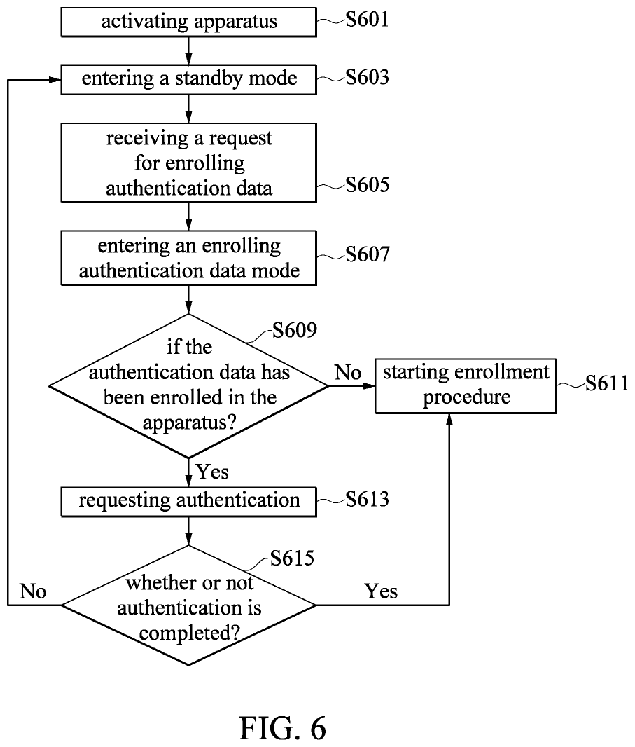

FIG. 6 shows a flow chart describing a self-enrollment method for enrolling authentication data according to one embodiment of the disclosure.

In the present process, such as in step S601, the portable authentication apparatus is switched on via a power-switching interface. According to the above embodiment, the power-switching interface can be used to implement multiple functions of the portable authentication apparatus. For example, the apparatus can be switched on by long-pressing the power-switching interface, the authentication data enrollment mode is activated by clicking the interface, and the apparatus is then switched off by another long-pressing action.

After that, in step S603, the portable authentication apparatus firstly enters a standby mode/idle mode. In one further aspect, if the portable authentication apparatus is a card type, a USB dongle type device or the like, the enrollment procedure will be initiated in the moment that the apparatus connects with host via the communication interface without entering the standby mode. In step S605, a micro-controller unit of the apparatus receives a request for enrolling authentication data. According to one of the embodiments, the request is generated by manipulating a power-switching interface using an action. The action is such as short pressing the power-switching interface with three times in succession. Alternatively, in one further aspect, the portable authentication apparatus provides another operating interface for this function. In the meantime, such as in step S607, when the portable authentication apparatus enters an authentication data enrollment mode, a software process is performed to process the self-enrollment method for enrolling the authentication data in the apparatus.

When the portable authentication apparatus enters the authentication data enrollment mode, an indicator light is used to prompt the process for reading the authentication data, e.g. the biometric features, or requesting an authentication procedure.

In the software process, such as in step S609, it is determined if a memory of the apparatus includes at least one enrolled authentication data. For example, the software process is configured to enquire if the biometric module (209, FIG. 2) of the apparatus has any previously-enrolled biometric data. If there is no enrolled authentication data in the apparatus, it would be a first time to start the portable authentication apparatus, or the previously-enrolled data is lost or deleted. Therefore, an enrollment procedure is performed, such as in step S611, to enroll a new authentication data.

Otherwise, if at least one authentication data has been enrolled in the apparatus, the portable authentication apparatus may request the user to first conduct the authentication process through an indicator light or a sound. In step S613, an authentication procedure is performed for requesting authentication using any of the enrolled authentication data. For example, the portable authentication apparatus utilizes an indicator light to prompt the user using his finger for the apparatus to read the biometric features, e.g. a fingerprint, via the biometric feature access interface (210, FIG. 2). In an aspect, the portable authentication apparatus has a security chip with a processor that allows the apparatus to verify the authentication data quickly.

In step S615, the micro-controller unit of the apparatus acknowledges if the authentication procedure is completed from the biometric module. If the authentication procedure is not yet done or fails, the process goes back to step S603 and the authentication apparatus stays in a standby mode. If the authentication has been done, the process goes to step S611 to start the enrollment procedure to enroll a new authentication data. It should be noted that the portable authentication apparatus can be a USB-dongle type device that can be activated and ready for authentication without entering the standby mode if the apparatus connects with the host via a specific communication interface, e.g. USB.

In an exemplary example, when the portable authentication apparatus is switched on, a user can activate the enrollment procedure in the apparatus by pressing a power button three times in succession. The portable authentication apparatus then enters an authentication data enrollment mode. An indicator light is used to guide the user to enroll his fingerprint. The user then follows the guide to run his finger along a fingerprint scanning interface of the apparatus. For example, the self-enrollment method requires the finger to move in a clockwise direction on the fingerprint scanning interface until the enrollment is done. The procedure can be prompted to the user by flashing the light, changing colors of the light or using a beep sound.

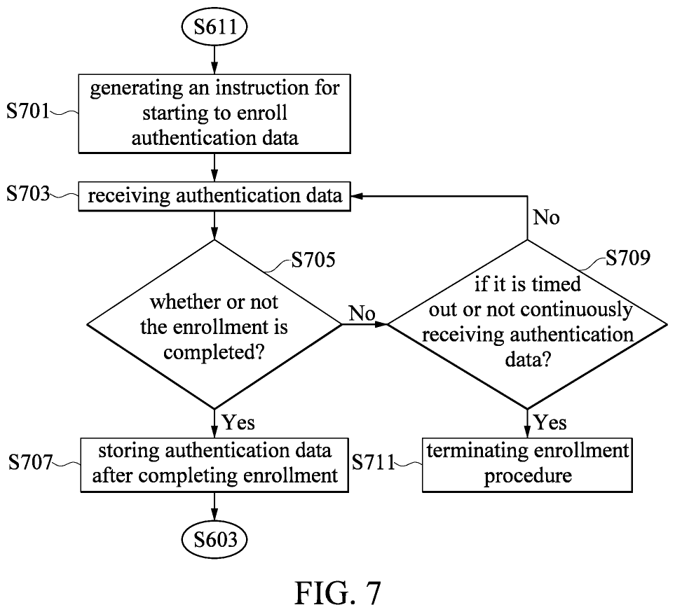

The software process operated in the micro-controller unit can determine if the portable authentication apparatus starts the enrollment procedure (step S611). Reference next is made to FIG. 7 which shows another flow chart of the self-enrollment method in one embodiment of the disclosure.

After the step S611 of FIG. 6, in step S701, the micro-controller unit controls the indicator light or sound of the apparatus to generate an instruction for starting to enroll the authentication data. In step S703, the apparatus starts to receive the authentication data. In step S705, it is determined whether or not the enrollment is completed. For example, the apparatus may require reading the fingerprint many times by repeating the reading steps if the apparatus needs to scan the fingerprint for processing the enrollment. The apparatus may also need to process the steps many times for obtaining other kinds of biometric features. If the enrollment is not yet done, such as in step S709, the process goes on determining if it is timed out or the authentication data cannot not be continuously received.

In the present step, the apparatus may need to obtain complete biometric data by reading the fingerprint images many times so as to generate accurate authentication data. The related software process may start timing and setting up a threshold when it determines the enrollment is done. The apparatus may fail to receive the complete authentication data when the enrollment procedure fails or cannot be continued. In step S711, the software process may erase all the authentication data buffered in the memory of the apparatus and terminate the current enrollment procedure.

Otherwise, the enrollment procedure continues (step S703) if the timeout does not occur and the apparatus can continuously receive the authentication data. The authentication data is stored into the memory if the enrollment is completed (step S707). In the meantime, a security code is generated through a security algorithm performed by the security authentication module of the portable authentication apparatus, and the security code may become the authentication data for identity verification of the apparatus. The process then goes back to step S603 of FIG. 6 for driving the portable authentication apparatus to stay in a standby mode and ready for next identity verification. The security code can be transferred to the host connected with the portable authentication apparatus, and the host can decode the security code and confirm the accuracy of data and completeness of authentication data by the security code.

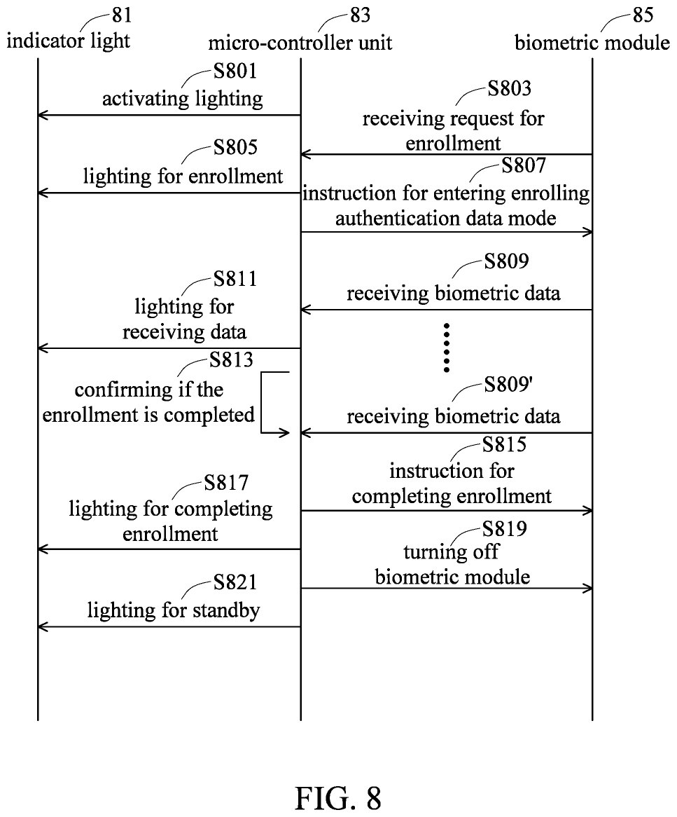

FIG. 8 shows a flow chart that describes the self-enrollment method operated in the authentication apparatus according to one embodiment of the disclosure. The procedure is mainly operated between a micro-controller unit 83 and a biometric module 85 of the portable authentication apparatus without any additional external device. Various changes made by indicator light 81 or sounds can be used to prompt the user the current operating modes: standby, ready for enrolling authentication data or in operation.

In the present process, in the beginning, the user can use the power-switching interface to switch on the power of the portable authentication apparatus. A micro-controller unit 83 generates an instruction for activating lighting to an indicator light 81 (step S801). The apparatus uses lighting or sound to indicate an active state of the apparatus.

After that, when the micro-controller unit 83 receives a request for enrolling authentication data as a user manipulates the authentication apparatus (step S803), the apparatus firstly enters an authentication data enrollment mode. The micro-controller unit 83 generates a signal for generating enrollment lighting to the indicator light 81 (step S805). Therefore the indicator light 81 can prompt the user that the apparatus is under the authentication data enrollment mode with a specific lighting. It should be noted that the apparatus can also utilize a sound to prompt the user the current operating mode. In the meantime, such as in step S807, the biometric module 85 is activated when receiving an instruction for entering the authentication data enrollment mode from the micro-controller unit 83. An enrollment procedure is initiated. The micro-controller unit 83 of the apparatus starts to read authentication data and to prompt the user to use an authentication interface. The micro-controller unit 83 can therefore receive the authentication data/biometric data from the biometric module 85 by repeating the reading steps such as steps S809 and S809′. The micro-controller unit 83 can generate a lighting signal for receiving data to the indicator light 81 (step S811). The micro-controller unit 83 continuously determines if the enrollment is done by confirming the procedure with the biometric module 85 (step S813).

When the micro-controller unit 83 confirms that the enrollment procedure is done, an instruction for completing enrollment is generated and transmitted to the biometric module 85 (step S815). At the same time, the enrollment procedure is terminated. The authentication data is stored into a memory of the portable authentication apparatus. A lighting instruction for completing enrollment is generated and delivered to the indicator light 81 (step S817). The biometric module 85 is de-activated (step S819). The micro-controller unit 83 makes the indicator light 81 generate lighting for standby (step S821). The user is therefore notified that the apparatus is now under a standby state.

To sum up the above description, the portable authentication apparatus described in the embodiments is able to perform a self-enrollment process in the apparatus so as to improve the traditional way that requires another computer for the authentication apparatus to complete enrollment using the authentication data. The portable authentication apparatus can achieve unexpected efficacy of the current known technology.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A self-enrollment method for enrolling authentication data in a portable authentication apparatus, comprising:
the portable authentication apparatus entering an authentication data enrollment mode after receiving a request for enrolling authentication data;
prompting the portable authentication apparatus to activate an enrollment procedure and starting to read authentication data;
receiving authentication data via an authentication interface of the portable authentication apparatus;
determining if the authentication data is completely enrolled until the enrollment procedure is done; and
terminating the enrollment procedure after the authentication data is completely enrolled, and storing the authentication data into a memory of the portable authentication apparatus.

2. The method according to claim 1, wherein the authentication data is a biometric data, and the authentication interface is a biometric feature access interface for reading biometric features so as to form the biometric data.

3. The method according to claim 1, wherein, when receiving the request for enrolling the authentication data, the portable authentication apparatus enquires if the memory includes at least one enrolled authentication data;
an authentication procedure is performed if the at least one enrolled authentication data exists and requires authentication to use the enrolled authentication data.

4. The method according to claim 3, wherein, when the portable authentication apparatus enters the authentication data enrollment mode, an indicator light is used to prompt that the portable authentication apparatus starts to read the authentication data or performs the authentication procedure firstly.

5. The method according to claim 4, wherein the authentication data is a biometric data, and the authentication interface is a biometric feature access interface for reading biometric features so as to form the biometric data.

6. The method according to claim 1, wherein, in the step for continuously determining if the authentication data is completely enrolled, the authentication data buffered in the memory is erased if the enrollment procedure fails, and the enrollment procedure terminates.

7. The method according to claim 6, wherein the authentication data is a biometric data, and the authentication interface is a biometric feature access interface for reading biometric features so as to form the biometric data.

8. A portable authentication apparatus comprising:
a micro-controller unit used to control operations of a plurality of circuit modules of the portable authentication apparatus;
a plurality of communication modules electrically connected with the micro-controller unit, including:
a bus module with a data interface used to connect with a host;
a first wireless communication module that connects with the host under a first wireless communication protocol; and
a second wireless communication module that connects with the host under a second wireless communication protocol;
a biometric module electrically connected with the micro-controller unit and reading biometric features via a biometric feature access interface;
a security authentication module electrically connected with the micro-controller unit, and obtaining biometric features generated by the biometric module by the micro-controller unit so as to generate a security code for authentication; and
a power management module electrically connected with the micro-controller unit and used to control a power supplied to the portable authentication apparatus;
wherein the micro-controller unit performs a self-enrollment method for enrolling authentication data in the apparatus, and the method comprises:
the portable authentication apparatus entering an authentication data enrollment mode after receiving a request for enrolling authentication data;
prompting the portable authentication apparatus to activate an enrollment procedure and starting to read authentication data;
receiving biometric features via a biometric feature access interface of the portable authentication apparatus so as to form authentication data;
determining if the authentication data is completely enrolled until the enrollment procedure is done; and
terminating the enrollment procedure after the authentication data is completely enrolled, and storing the authentication data into a memory of the portable authentication apparatus.

9. The apparatus according to claim 8, wherein the portable authentication apparatus is a card-type device or a USB-type dongle that includes an internal battery module supplying power to the portable authentication apparatus by the power management module; the portable authentication apparatus connects with the host by one of the plurality of communication modules for conducting authentication.

10. The apparatus according to claim 8, wherein, when receiving the request for enrolling the authentication data, the portable authentication apparatus enquires if the memory includes at least one enrolled authentication data; an authentication procedure is performed if the at least one enrolled authentication data exists and requires authentication using the enrolled authentication data.

11. The apparatus according to claim 10, when the portable authentication apparatus enters the authentication data enrollment mode, an indicator light is used to prompt that the portable authentication apparatus starts to read the authentication data or performs the authentication procedure firstly.

12. The apparatus according to claim 11, wherein the portable authentication apparatus is a card-type device or a USB-type dongle that includes an internal battery module that supplies power to the portable authentication apparatus by the power management module; the portable authentication apparatus connects with the host by one of the plurality of communication modules for conducting authentication.

13. The apparatus according to claim 8, wherein the biometric module is a fingerprint recognition module, and the biometric feature access interface disposed on a surface of the portable authentication apparatus is used to read a fingerprint image.

14. The apparatus according to claim 13, wherein the portable authentication apparatus is a card-type device or a USB-type dongle that includes an internal battery module that supplies power to the portable authentication apparatus by the power management module; the portable authentication apparatus connects with the host by one of the plurality of communication modules for conducting authentication.
